(19) United States
(12) Patent Application Publication
(10) Pub. No.: US 2006/0274492 A1
(43) Pub. Date: Dec. 7, 2006

(54) Portable computer having a keyboard coupled to a computer main body

(75) Inventor: Su-hyeon Roh, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/437,822

(22) Filed: May 22, 2006

(30) Foreign Application Priority Data
Jun. 1, 2005 (KR) 2005-46608

(51) Int. Cl. G06F 1/16

(52) U.S. Cl. 361/683; 361/680

(57) ABSTRACT

A portable computer having a computer main body and a display rotatably coupled to the computer main body includes a keyboard, a keyboard accommodating part provided in the computer main body to accommodate the keyboard, a stopping member provided at the computer main body, and an operating lever to operate the stopping member to move the stopping member between a coupling position in which the stopping member couples with the keyboard accommodated in the keyboard accommodating part and a separating position in which the stopping member uncouples with the keyboard. Accordingly, the keyboard can more stably secured in the computer main body, and easily uncoupled from the computer main body.

### CROSS-REFERENCE TO RELATED APPLICATIONS

This application claims the benefit under 35 U.S.C. § 119 of Korean Patent Application No. 2005-46608, filed on Jun. 1, 2005, in the Korean Intellectual Property Office, the disclosure of which is incorporated herein in its entirety by reference.

### BACKGROUND OF THE INVENTION

1. Field of the Invention

The present general inventive concept relates to a portable computer, and more particularly, to a portable computer having an improved structure to couple a computer main body and a keyboard.

2. Description of the Related Art

In general, a portable computer comprises a computer main body and a display rotatably coupled with the computer main body and displaying an image thereon.

The computer main body is provided with a keyboard to input data and a supporter accommodating the keyboard to be installed in the computer main body.

Such an installation structure of the keyboard in the conventional portable computer has been disclosed in Korean Utility Model Application No. 20-1995-7806. The installation structure of the keyboard installation in the conventional portable computer comprises a supporter formed to seat a keyboard stably in the computer main body, a hook provided in a bottom side of the keyboard, a rotating plate provided in the supporter to couple with the hook, and a spring which provides an elastic force on the rotating plate so that the hook hooks into the rotating plate and is maintained in the rotating plate.

In such a conventional portable computer, the hook provided in the keyboard hooks into the rotating plate and is maintained in the rotating plate and then the keyboard may be installed in the computer main body.

In such a conventional portable computer, the keyboard is installed in the computer main body. However, the keyboard seated in the computer main body by the elastic force of the spring is not stable. It is desirable that the keyboard be more stably seated in the computer main body.

Furthermore, it is desirable that the keyboard can be readily uncoupled from the computer main body.

### SUMMARY OF THE INVENTION

Accordingly, the present general inventive concept provides a portable computer in which a keyboard is more stably coupled to a computer main body, and the keyboard is readily uncoupled with a computer main body.

Additional aspects of the present general inventive concept will be set forth in part in the description which follows and, in part, will be obvious from the description, or may be learned by practice of the present general inventive concept.

The foregoing and/or other aspects of the present general inventive concept may be achieved by providing a portable computer having a computer main body and a display rotatably coupled to the computer main body, the portable computer comprising a keyboard, a keyboard accommodating part provided in the computer main body to accommodate the keyboard, a stopping member provided at the computer main body, and an operating lever to operate the stopping member to move the stopping member between a coupling position in which the stopping member couples with the keyboard accommodated in the keyboard accommodating part and a separating position in which the stopping member uncouples with the keyboard.

The keyboard may comprise a plurality of key buttons and a keyboard base to support the plurality of key buttons, and the stopping member may couple and uncouple with the keyboard base.

The stopping member may be rotatably provided at the computer main body.

The stopping member may comprise a rotating body rotatably provided at the computer main body and a stopping protrusion protruding from the rotating body to couple with the keyboard base when the stopping member is at the coupling position.

The stopping protrusion may comprise a slant part inclined in a rotational direction to gradually press a surface of the keyboard base as the stopping member rotates to the coupling position.

The rotating body may comprise a pinion part having a gear shape, and the operating lever may be provided with a rack part to engage the pinion part to rotate the rotating body as the lever moves.

The operating lever may comprise a rod shape, and the computer main body may comprise a lever guide to accommodate the operating lever to guide movement of the lever in a lengthwise direction thereof.

The portable computer may further comprise a rotating restriction part disposed between the operating lever and the stopping member to restrict a rotation of the stopping member.

The rotating restriction part may comprise a restricting protrusion provided at the stopping member, and one or more stoppers provided at the operating lever to restrict a rotation of the restricting protrusion within a predetermined angle.

The portable computer may further comprise a locking unit provided between the computer main body and the operating lever to restrict the operating lever from moving when the stopping member is in the coupling position.

The locking unit may comprise a locking protrusion provided at the operating lever and a locking protrusion fastening part provided at the computer main body to couple with the locking protrusion at a predetermined force.

The portable computer may further comprise one or more coupling protrusions provided at a side of the keyboard opposite to a side at which the stopping member couples with the keyboard, wherein the keyboard accommodating part comprises one or more coupling protrusion accommodating parts to accommodate the one or more coupling protrusions.

The foregoing and/or other aspects of the present general inventive concept may also be achieved by providing a portable computer comprising a keyboard, and a computer main body comprising a keyboard accommodating portion to accommodate the keyboard therein, one or more stopping members to move between a first position to secure the keyboard within the keyboard accommodating portion and a second position to release the keyboard from the keyboard accommodating portion, and an operating lever disposed in the computer main body to control the movement of the stopping members by a movement thereof.

The foregoing and/or other aspects of the present general inventive concept may also be achieved by providing a portable computer comprising a computer main body having a keyboard accommodating portion to accommodate a keyboard, a keyboard coupling device having one or more coupling members to secure the keyboard within the keyboard accommodating portion to release the keyboard from the keyboard accommodating portion and an operating lever to control the coupling members according to a movement thereof, and a locking unit to prevent the operating lever from moving when the coupling members secure the keyboard within the keyboard accommodating portion.

The foregoing and/or other aspects of the present general inventive concept may also be achieved by providing a portable computer comprising a keyboard, and a computer main body comprising a keyboard accommodating portion to accommodate the keyboard therein and one or more rotatable stopping units moveable to a lock position to prevent the keyboard from being separated from the keyboard accommodating portion and to an unlock position to allow the keyboard to be separated from the keyboard accommodating portion.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a portable computer according to an embodiment of the present general inventive concept;

FIG. 2 is an exploded perspective view illustrating a keyboard of the portable computer of FIG. 1;

FIGS. 3 and 4 are exploded perspective views illustrating a keyboard coupling device of the portable computer of FIG. 1;

FIGS. 5-7 are perspective views illustrating operations of the keyboard coupling device of the portable computer of FIG. 1.

FIGS. 8A and 8B are exploded perspective views illustrating electrical connections between the keyboard and a computer main body of the portable computer of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

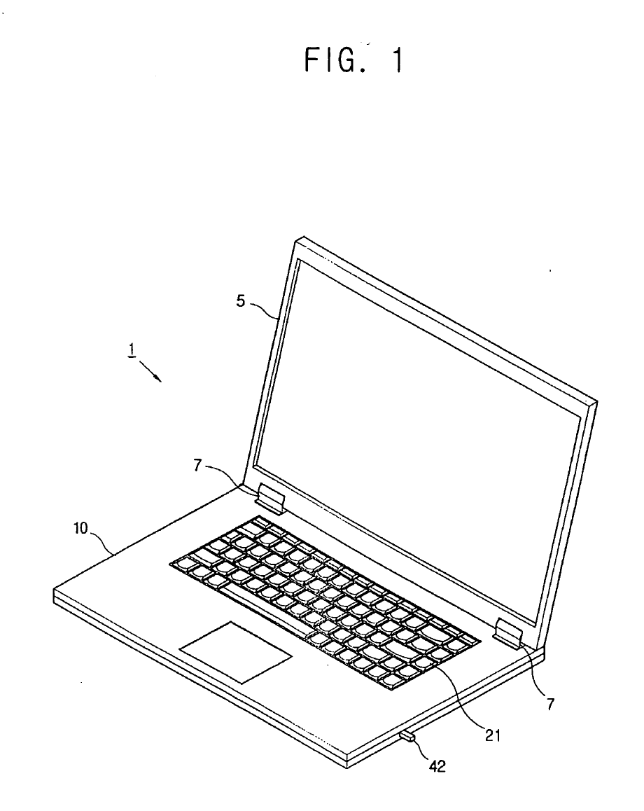

FIGS. 1-4 illustrate a portable computer 1 according to an embodiment of the present general inventive concept. Referring to FIGS. 1-4, the portable computer 1 comprises a computer main body 10, a display 5 tiltably coupled with the computer main body 10, a keyboard 21, a keyboard accommodator 11 to accommodate the keyboard 21 in the computer main body 10, and a keyboard coupling device 30 to couple and decouple the keyboard 21 in the keyboard accommodating part 11.

The display 5 displays an image thereon according to an image signal. The display 5 may be provided with a driving circuit (not shown) to form the image according to the image signal and to drive the display 5 to display the image thereon. A thin, light LCD panel can be used as the display 5. However, a flat display panel, such as a PDP panel, may also be used as the display 5. The display 5 can be tiltably coupled to a rear surface of the computer main body 10 by one or more hinge parts 7.

The computer main body 10 can be stably seated on horizontal plane, such as a table or a lap of a user. Components such as a main board and a CPU are provided in the computer main body 10 to generate the image signal, etc.

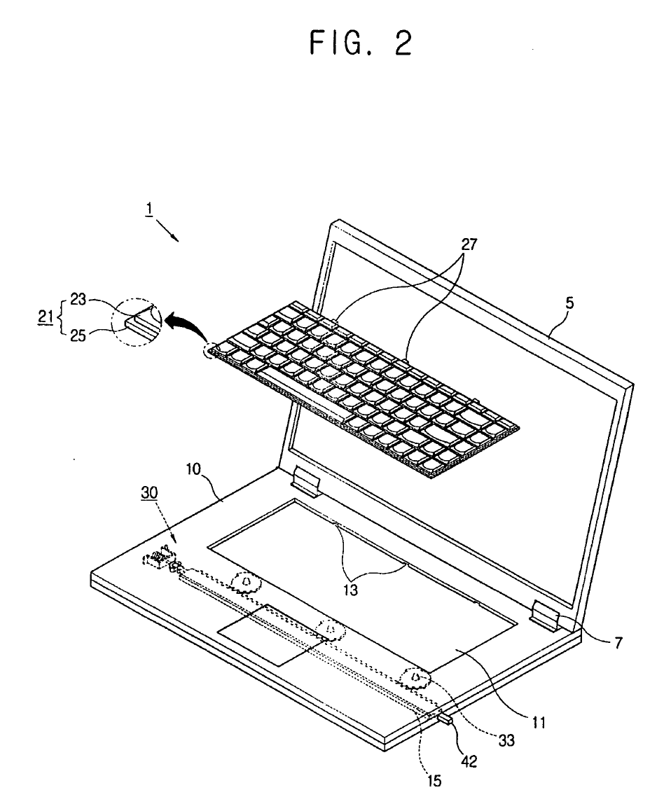

As illustrated in FIG. 2, the keyboard 21 comprises a plurality of key buttons 23 to input data, etc., and a keyboard base 25 to support the key buttons 23. The keyboard 21 is accommodated in the keyboard accommodator 11 provided in the computer main body 10 and electrically connected with the computer main body 10 to allow the key buttons 23 to input the data. The keyboard 21 is provided with one or more coupling protrusions 27 disposed at a first side of the keyboard 21, which is opposite to a second side of the key board 21 at which one or more stopping members 31 are coupled.

The coupling protrusions 27 project from a first side of the keyboard base 25 to be accommodated in corresponding coupling protrusion accommodators 13 provided at a first side of the keyboard accommodator 11. As illustrated in FIG. 2, three of the coupling protrusions 27 can be provided, but the present general inventive concept is not limited thereto, and less than two or more than four may be provided.

A stopping protrusion 36 of each stopping member 31, to be described later, is coupled to a second side of the keyboard base 25.

As illustrated in FIG. 2, the coupling protrusions 27 can be provided at a rear side of the keyboard base 25, and the stopping members 31 can be coupled to a front side of the keyboard base 25, but the present general inventive concept is not limited thereto. For example, the stopping members 31 can be coupled to the rear side of the keyboard base 25 and the coupling protrusions 27 can be provided in the front side of the keyboard base 25. Furthermore, the coupling protrusions 27 may also be provided in left or right sides of the keyboard base 25.

The keyboard accommodator 11 is concavely formed in an upper side of the computer main body 10 to accommodate the keyboard 21 therein. The first side of the keyboard accommodator 11 is formed with one or more of the coupling protrusion accommodators 13 to accommodate the coupling protrusions 27 of the keyboard 21. A second side of the keyboard accommodator 11 is formed with the stopping member 31 to couple with the keyboard 21.

The coupling protrusion accommodators 13 are provided to correspond to the coupling protrusions 27. Each coupling accommodator 13 accommodates and couples with the corresponding coupling protrusion 27 to prevent the corresponding coupling protrusion 27 from being uncoupled therefrom in an upward direction.

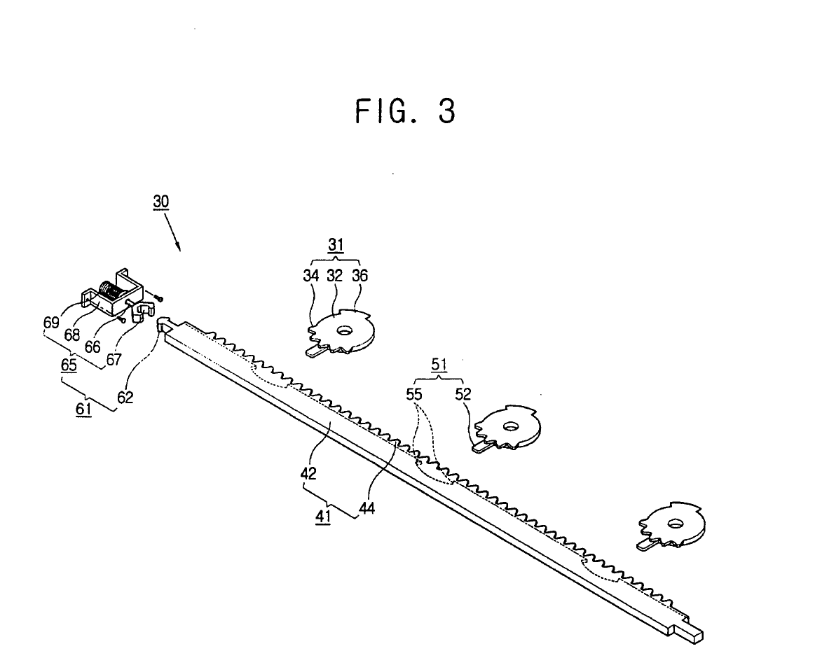

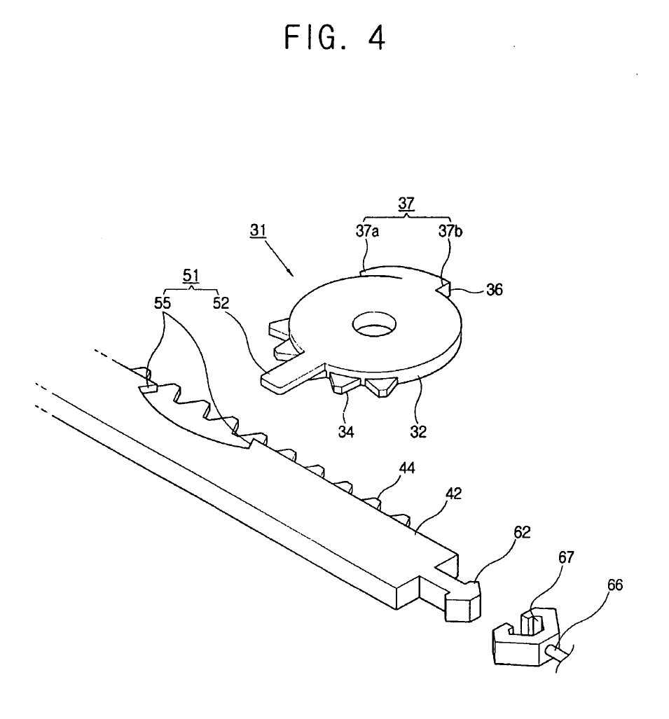

As illustrated in FIGS. 3 and 4, the keyboard coupling device 30 comprises the stopping members 31 provided at the computer main body 10 and an operating lever 41. The operating lever 41 operates the stopping members 31 to move the stopping members 31 between a coupling position in which the stopping members 31 are coupled with the keyboard 21 and secure the keyboard 21 within the keyboard accommodator 11 and a separating position in which the stopping members 31 are uncoupled from the keyboard 21 and release the keyboard 21 from the keyboard accommodator 11. The keyboard coupling device 30 further comprises a rotation restriction part 51 provided between the operating lever 41 and each stopping member 31 to restrict rotation of each stopping member 31. The keyboard coupling device 30 may further comprise a locking unit 61 provided between the computer main body 10 and the operating lever 41 to restrict the movement of the operating lever 41 when the stopping members 31 are in the coupling position to lock the stopping members 31 in the coupling position. As illustrated in FIG. 2, the keyboard coupling device 30 can be provided at a front portion of the keyboard accommodator 11 to couple and uncouple with the keyboard 21. However, the keyboard coupling device 30 may also be provided at a back or side portion of the keyboard accommodator 11.

As illustrated in FIG. 2 and FIG. 3, three of the stopping members 31 can be provided to couple and uncouple with the keyboard base 25. However, the present general inventive concept is not limited thereto, and two or less, or four or more of the stopping members 31 may be provided to couple and uncouple with the keyboard base 25. Each stopping member 31 is rotatably provided with respect to a rotating shaft 33 provided at the computer main body 10. Each stopping member 31 comprises a rotating body 32 rotatably provided about the rotating shaft 33 and the stopping protrusion 36 protruding from the rotating body 32 to couple with the keyboard base 25 of the keyboard 21 when the stopping member 31 is in the coupling position. As illustrated in FIGS. 2 and 3, each stopping member 31 is coupled to the computer main body 10 via the rotating shaft 33, and can be provided in front of the keyboard accommodator 11.

The rotating body 32 is rotatably coupled with the rotating shaft 33, and can have a cross section of a round shape. The rotating body 32 is provided with a pinion part 34 having a gear shape.

The pinion part 34 can be provided to a partial portion of a circumference of the rotating body 32 to engage with a rack part 44 of the operating lever 41. Alternatively, the pinion part 34 can be provided to the entire circumference of the rotating body 32.

The stopping protrusion 36 outwardly projects from a first side of the rotating body 32. The stopping protrusion 36 can project in a circular arc shape to support an upper side of the keyboard base 25 when the stopping member 31 is rotated to the coupling position. The stopping protrusion 36 can be provided with a slant part 37 inclined in a direction of the rotation so that when each stopping member 31 rotates to the coupling position, the slant part 37 of the stopping protrusion 36 gradually presses on the upper side of the keyboard base 25 to secure the keyboard 21 within the key board accommodator 11. The stopping protrusion 36 may be provided with the circular arc shape having an angle width of 40 degrees to 60 degrees approximately, but the present general inventive concept is not limited thereto.

The slant part 37 can be provided at a lower side of the stopping protrusion 36 to contact the keyboard base 25. FIG. 4 is a view illustrating lower sides of the stopping member 31 and the operating lever 41. The slant part 37 can be provided to slope downwardly between a first side 37a thereof and a second side 37b thereof in a rotating direction of the stopping protrusion 36. In other words, when the stopping member 31 rotates to the coupling position and the stopping protrusion 36 couples with the upper side of the keyboard base 25, the first side 37a of the slant part 37 is upwardly inclined from the second side 37b such that the slant part 37 gradually contacts the upper side of the keyboard base 25 when the stopping member 31 rotates. Furthermore, the slant part 37 presses the keyboard base 25 further into the keyboard accommodator 11 from the first side 37a of the slant part 37 to the second side 37b of the slant part 37 while the stopping member 31 rotates.

The operating lever 41 is accommodated and guided in a lever guide 15 provided at the computer main body 10. The operating lever 41 comprises a lever main body 42 provided in a rod shape, and the rack part 44 formed at the lever main body 42 to correspond to the pinion part 34 provided at the rotating body 32 of each stopping member 31.

A first side of the lever main body 42 is accommodated in the lever guide 15 provided in the computer main body 10, while a second side of the lever main body 42 is exposed externally of the computer main body 10 to allow the user to press the lever guide 15. Accordingly, the user may control the operating lever 41 to move within the lever guide 15 in a lengthwise direction of the lever main body 42.

The rack part 44 provided at the lever main body 42 to engage the pinion part 34 can have a gear shape. When the lever main body moves in the lever guide 15, the rack part 44 engages with the pinion part 32 to control the rotating body 32 and the stopping protrusion 36 protruding therefrom to rotate.

The rotating restriction part 51 comprises a restricting protrusion 52 provided at each stopping member 31 and one or more stoppers 55 provided the operating lever 41 to restrict rotation of each restricting protrusion 52.

The restricting protrusion 52 is provided at a second side of the rotating body 32 to outwardly project from the rotating body 32. The restricting protrusion 52 rotates integrally with the rotating body 32 and restricts the rotation of the rotating body 32 when the stopper 55 restricts the rotation of the restricting protrusion 52.

As illustrated in FIG. 3, a pair of the stoppers 55 can be provided at the lever main body 42 to restrict each restricting protrusion 52. The stoppers 55 in each pair can be spaced apart by a predetermined distance to accommodate the corresponding restricting protrusion 52 therebetween. The distance between the stoppers 55 in each pair can restrict the rotation of the restricting protrusion 52 to control each stopping member 31 to rotate between the coupling position in which the stopping member 31 couples with the keyboard 21 and the separating position in which the stopping member 31 uncouples from the keyboard 21. According to an embodiment of the present general inventive concept, the distance between the stoppers 55 in each pair can be set to restrict the rotation of the restricting protrusion 52 so that the stopping protrusion 36 protruding from the rotating body 32 can rotate to an angle of 90 degrees approximately.

The locking unit 61 comprises a locking protrusion 62 provided at the operating lever 41 and a locking protrusion fastening part 65 provided at the computer main body 10 to couple with the locking protrusion 62 at a predetermined force.

The locking protrusion 62 can be provided at an end of the first side of the lever main body 42. The locking protrusion 62 is formed with projecting portions projecting from opposite sides thereof to engage with an engagement member 66 of the locking protrusion fastening part 65. Alternatively, the locking protrusion 52 may be provided at the computer main body 10 and the locking protrusion fastening part 65 may be provided at the operating lever 41.

The locking protrusion fastening part 65 comprises the engagement member 66, an engagement supporting part 68, and an elastic member 69. The engagement member 66 is provided to engage with the locking protrusion 62. The engagement supporting part 68 supports the engagement member 66 to allow the engagement member 66 to move a predetermined distance with respect to the computer main body 10. The elastic member 69 biases the engagement member 66 a direction toward the locking protrusion 62.

An engagement part 67 to engage with the projecting portions of the locking protrusion 62 is provided to a first side of the engagement member 66. The elastic member 69 biases the second side of the engagement member 66 in a direction of the engagement part 67.

The engagement supporting part 68 can be coupled by screws, etc., to the computer main body 10. The engagement supporting part 68 supports the engagement member 66 to prevent the engagement member 66 from separating from the elastic member 69. The engagement supporting part 68 supports the engagement member 66 to move to the predetermined distance when the locking protrusion 62 moves in the direction of the engagement member 66.

The elastic member 69 is accommodated within the engagement supporter 68 to bias the engagement member 66 toward the locking protrusion 62. The elastic member 69 can provided as a coil spring or a various type of a plate, spring, rubber material, etc.

The engagement part 67 engages with the locking protrusion 62 at the predetermined force. The predetermined engagement force of the engagement part 67 is less than an elastic force of the elastic member to bias the locking protrusion 62 when the locking protrusion 62 presses against the elastic member 69 via the engagement member 66 and compresses the elastic member 69.

Accordingly, when the user presses the lever main body 42 with the predetermined engagement force to move the lever main body within the lever guide 15 toward the locking protrusion fastening part 65, the locking protrusion 62 engages with the engagement part 67 and the stopping members 31 are held at the coupling position. Further, the user can disengage the locking protrusion 62 from the engagement part 67 by pressing the lever main body 42 within the lever guide 15 toward the locking protrusion fastening part 65 again to compress the elastic member 69. The locking protrusion 62 is then disengaged from the engagement part 67 due to the elastic force of the elastic member 69. Accordingly, the lever main body 42 can then be moved to the separating position.

Alternatively, at least one of the locking protrusion 62 and the engagement member 66 may be provided with a magnet to couple to couple the locking protrusion 62 and the engagement member 66, instead of the engagement part 67 and the projecting portions of the locking protrusion 62. A coupling force of the magnet can be less than the elastic force of the elastic member 69 such that the locking unit 62 can be released from the engagement member 66 by the elastic force.

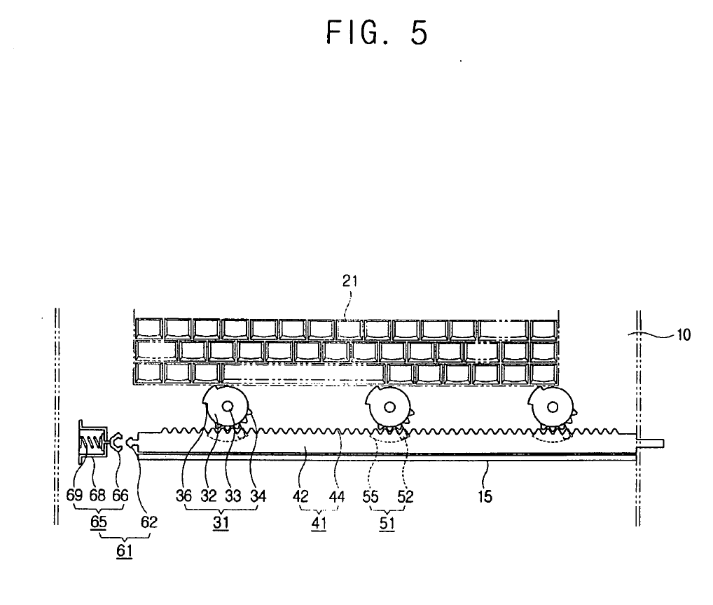

FIGS. 5-7 illustrate operations of the keyboard coupling device 30 of the portable computer 1. Referring to FIGS. 1-7, operations to couple the keyboard 21 to the computer main body 10 and to separate the keyboard 21 from the computer main body 10 are described below.

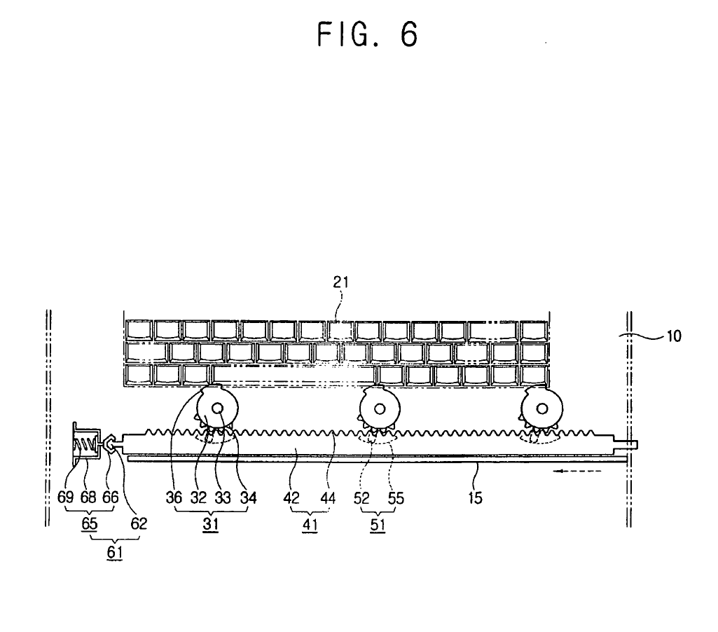

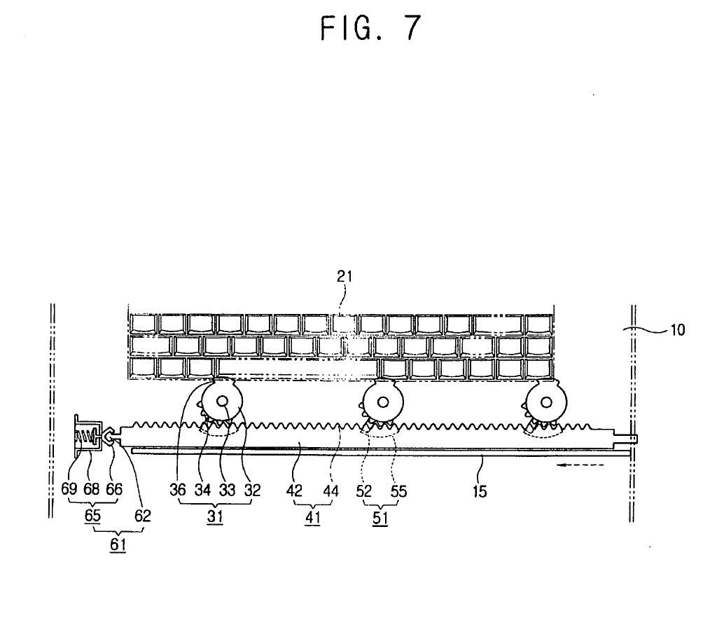

In order to couple the keyboard 21 to the computer main body 10, the keyboard 21 is placed into the keyboard accommodator 11. The coupling protrusions 27 provided at the keyboard base 25 are inserted into the corresponding coupling protrusion accommodators 13 provided in the keyboard accommodator 11. As illustrated in FIG. 5, when the keyboard 21 is separate from the computer main body 10, the stopping members 31 are in the separation position in which the stopping protrusion of each stopping member 31 is rotated away from the keyboard 21, the locking protrusion 62 is separated from the engagement member 66, and the second side of the lever main body 42 projects externally from the computer main body 10. As illustrated in FIGS. 6-7, the lever main body 42 is then pressed toward the locking protrusion fastening part 65. The rack part 44 provided at the lever main body 42 engages with the pinion 34 provided at each stopping member 31 to rotate each stopping member 31 to the coupling position in which the stopping protrusion 36 secures the keyboard 21 within the keyboard accommodator 11. Further, the stopping protrusion 36 stably supports the keyboard base 25 during the rotation of the stopping members 31 as the slant part 37 of the stopping protrusion 36 presses the keyboard base 25 gradually. When the lever main body 42 is pressed toward the locking protrusion fastening part 65 to rotate the stopping members 31 to the coupling position, the locking protrusion 62 engages with the engagement part 67 to lock the stopping member 31 in the coupling position.

in order to separate the keyboard 21 from the computer main body 10 when the stopping members 31 are locked in the coupling position, the user presses the lever main body 42 toward the locking protrusion fastening part 65. The lever main body 42 is restricted in a distance to move toward the locking protrusion fastening part 65 by the restricting protrusions 52 and the stoppers 55 of the rotating restriction part 51. When the lever body 42 is pressed toward the locking protrusion fastening part 65, the lever body 42 compresses the elastic member 69. When the lever body 42 is released, the elastic member 69 applies the elastic force to the engagement member 66 and the locking protrusion 62 disengages from the engagement part 67 of the engagement member 66 by the elastic force of the elastic member 69. The elastic force causes the lever main body 42 to move away from the locking protrusion fastening part 65 such that the second side of the lever main body 42 projects externally from the computer main body 10. When the lever main body 42 moves away from the locking protrusion fastening part 65, the lever main body 42 rotates the stopping members 31 to the separating position in which the stopping protrusion 36 of each stopping member 31 is rotated away from the keyboard 21. The lever main body 42 is restricted in a distance to move away from the locking protrusion fastening part 65 by the restricting protrusions 52 and the stoppers 55 of the rotating restriction part 51. When the stopping members 31 are in the separating position, the user can lift the keyboard 21 so that the coupling protrusions 27 provided at the keyboard base 25 separate from the coupling protrusion accommodating parts 13 provided at the keyboard accommodator 11. Accordingly, the keyboard 21 can be easily separated from the keyboard accommodator 11 of the computer main body 10.

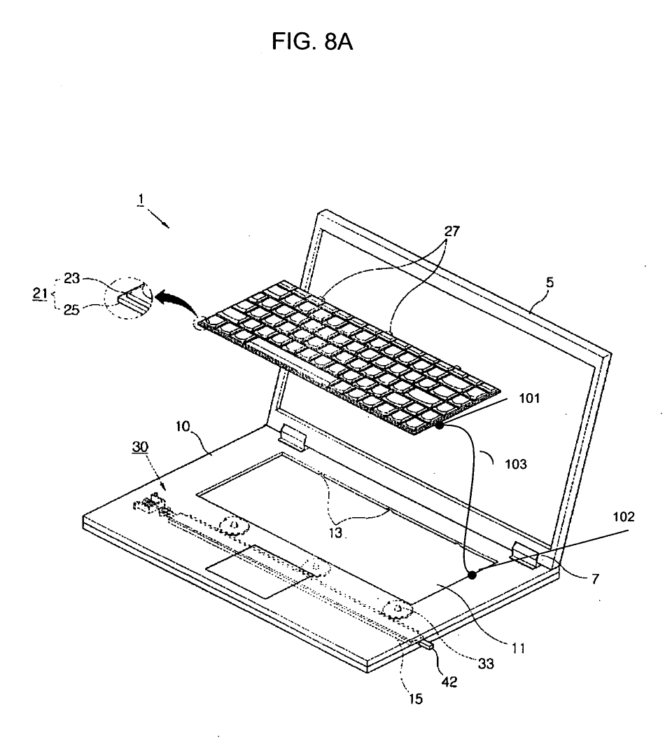

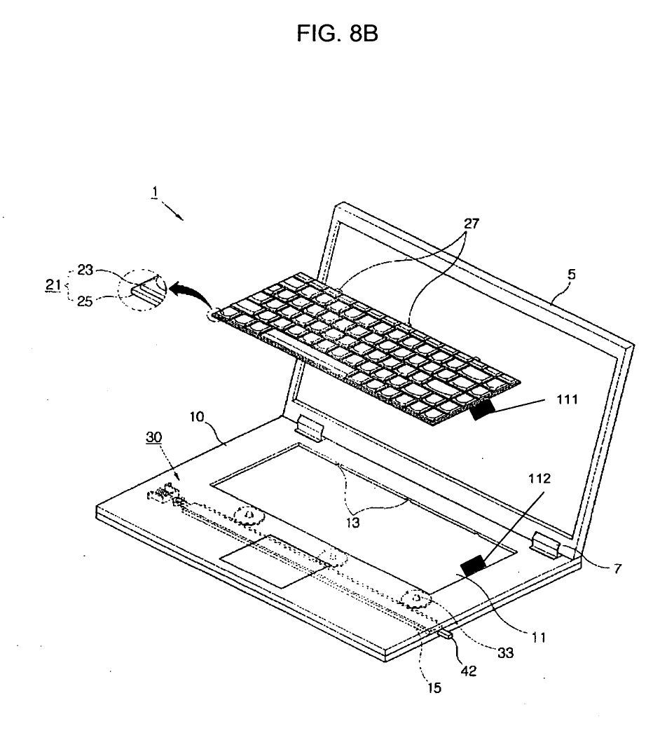

FIGS. 8A and 8B illustrate electrical connections between the key board 21 and the computer main body 10. Referring to FIG. 8A, the keyboard can include a first port 101 and the computer main body can include a second port 102 electrically connectable to the first port 101 of the keyboard 21. When the keyboard 21 is separated from the keyboard accommodator 11 of the computer main body 10, the first port 101 of the keyboard 21 and the second port 102 of the computer main body 10 can be electrically connected through a cable 103, or the like. Alternatively, it is possible that the keyboard 21 and the computer main body 10 can communicate wirelessly when the keyboard 21 is separated from the keyboard accommodator 11 of the computer main body 10.

Referring to FIG. 8B, the keyboard 21 can include a first terminal 111 and the computer main body 10 can include a second terminal 112 disposed at a predetermined position of the keyboard accommodator 11 to connect with the first terminal 111 of the keyboard 21 when the keyboard 21 is coupled within the keyboard accommodator 11. Accordingly, when the keyboard coupling device 30 couples the keyboard 21 within the keyboard accommodator 11, the first and second terminals 111 and 112 are connected to electrically connect the keyboard 21 to the computer main body 10.

As described above, the present general inventive concept provides a portable computer in which a user can press an operating lever to control a keyboard to easily couple and uncouple with a computer main body. Also, a stopping member can be provided in the portable computer to support the keyboard.

Furthermore, a slant part can be provided at a stopping protrusion such that the stopping protrusion gradually couples with a keyboard base as the stopping member rotates. Also, a rotating restriction part and a locking unit can be provided in the portable computer so that the user can safely and easily manipulate the operating lever.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable computer having a computer main body and a display rotatably coupled to the computer main body, the portable computer comprising:
a keyboard;
a keyboard accommodating part provided in the computer main body to accommodate the keyboard;
a stopping member provided at the computer main body; and
an operating lever to operate the stopping member to move the stopping member between a coupling position in which the stopping member couples with the keyboard accommodated in the keyboard accommodating part and a separating position in which the stopping member uncouples with the keyboard.

2. The portable computer according to claim 1, wherein the keyboard comprises a plurality of key buttons and a keyboard base to support the plurality of key buttons, and the stopping member couples and uncouples with the keyboard base.

3. The portable computer according to claim 2, wherein the stopping member is rotatably provided at the computer main body.

4. The portable computer according to claim 3, wherein the stopping member comprises:
a rotating body rotatably provided at the computer main body; and
a stopping protrusion protruding from the rotating body to couple with the keyboard base when the stopping member is at the coupling position.

5. The portable computer according to claim 4, wherein the stopping protrusion comprises:
a slant part inclined in a rotational direction to gradually press a surface of the keyboard base as the stopping member rotates to the coupling position.

6. The portable computer according to claim 4, wherein the rotating body comprises:
a pinion part having a gear shape, and the operating lever is provided with a rack part to engage the pinion part to rotate the rotating body as the operating lever moves.

7. The portable computer according to claim 6, wherein:
the operating lever comprises a rod shape; and
the computer main body comprises a lever guide to accommodate the operating lever to guide movement of the operating lever in a lengthwise direction thereof.

8. The portable computer according to claim 7, further comprising:
a rotating restriction part disposed between the operating lever and the stopping member to restrict a rotation of the stopping member.

9. The portable computer according to claim 8, wherein the rotating restriction part comprises a restricting protrusion provided at the stopping member, and one or more stoppers provided at the operating lever to restrict a rotation of the restricting protrusion within a predetermined angle.

10. The portable computer according to claim 1, further comprising:
a locking unit provided between the computer main body and the operating lever to restrict the operating lever from moving when the stopping member is in the coupling position.

11. The portable computer according to claim 10, wherein the locking unit comprises a locking protrusion provided at the operating lever and a locking protrusion fastening part provided at the computer main body to couple with the locking protrusion at a predetermined force.

12. The portable computer according to claim 11, wherein the locking protrusion fastening part comprises:
an engaging member to engage with the locking protrusion when the locking protrusion when the locking protrusion is moved by the operating lever toward the engaging member at the predetermined force; and
an elastic member connected to the engaging member to apply an elastic force to the engaging member to disengage to locking protrusion from the engaging member when operating lever presses the locking portion against the engaging member to compress the elastic member.

13. The portable computer according to claim 1, further comprising:
one or more coupling protrusions provided at a side of the keyboard opposite to a side at which the stopping member couples with the keyboard, wherein the keyboard accommodating part comprises one or more coupling protrusion accommodating parts to accommodate the one or more coupling protrusions.

14. A portable computer comprising:
a keyboard; and
a computer main body comprising a keyboard accommodating portion to accommodate the keyboard therein, one or more stopping members to move between a first position to secure the keyboard within the keyboard accommodating portion and a second position to release the keyboard from the keyboard accommodating portion, and an operating lever disposed in the computer main body to control the movement of the stopping members by a movement thereof.

15. The portable computer according to claim 14, wherein the computer main body further comprises a locking unit to prevent the operating lever from moving when the stopping members are in the first position to lock the stopping members at the first position.

16. The portable computer according to claim 14, wherein the stopping members rotate between the first and second positions, and each of the stopping members is slanted to gradually press the keyboard further into the keyboard accommodating portion as the stopping members rotate to the first position.

17. The portable computer according to claim 14, wherein the operating lever protrudes externally from the computer main body to allow a user to control the movement thereof.

18. A portable computer according to claim 14, further comprising:
a first port provided at the keyboard;
a second port provided at the computer main body; and
a cable to electrically connect the first and second ports when the keyboard is released from the keyboard accommodating portion of the computer main body.

19. The portable computer according to claim 14, wherein the keyboard comprises a first terminal, and the computer main body further comprises a second terminal to automatically electrically connect to the first terminal when the keyboard is secured within the keyboard accommodating portion of the computer main body.

20. A portable computer comprising:
a computer main body having a keyboard accommodating portion to accommodate a keyboard;
a keyboard coupling device having one or more coupling members to secure the keyboard within the keyboard accommodating portion to release the keyboard from the keyboard accommodating portion and an operating lever to control the coupling members according to a movement thereof; and
a locking unit to prevent the operating lever from moving when the coupling members secure the keyboard within the keyboard accommodating portion.

21. The portable computer according to claim 20, wherein the locking unit comprises:
an engaging part to engage with a portion of the operating lever when the operation lever controls the coupling members to secure the keyboard within the keyboard accommodating portion; and
a release mechanism to disengage the portion of the operating lever from the engaging part to allow the operating lever to control the coupling members to release the keyboard from the keyboard accommodating portion.

22. The portable computer according to claim 20, wherein the release mechanism comprises an elastic member to apply an elastic force to the engaging part to disengage the portion of the operating lever from the engaging part when the operating lever presses the engaging part against the elastic member and compresses the elastic member.

23. A portable computer comprising:
a keyboard; and
a computer main body comprising a keyboard accommodating portion to accommodate the keyboard therein and one or more rotatable stopping units movable to a lock position to prevent the keyboard from being separated from the keyboard accommodating portion and to an unlock position to allow the keyboard to be separated from the keyboard accommodating portion.

24. The portable computer according to claim 23, wherein when the one or more rotatable stopping units are in the unlock position, the keyboard is not electrically connected to the computer main body.

25. The portable computer according to claim 23, wherein when the one or more rotatable stopping units are in the unlock position, the keyboard is electrically connected to the computer main body through a connection formed therebetween.
